(19) United States
(12) Patent Application Publication
(10) Pub. No.: US 2004/0194278 A1
(43) Pub. Date: Oct. 7, 2004

(54) Tubular goods with expandable threaded connections

(75) Inventors: Leland M. Brill, Hughes Springs, TX (US); Bluford W. Lowery, Linden, TX (US); Edmond L. Miller, New Boston, TX (US); Gary H. Pollan, Daingerfield, TX (US); Gregory W. Ball, Hughes Springs, TX (US); Bowman A. Urech, Plano, TX (US); Tracy Eugene Bassham, Hughes Springs, TX (US); Harold Michael Grimmett, Hughes Springs, TX (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: Lone Star Steel Company

(21) Appl. No.: 10/828,069

(22) Filed: Apr. 20, 2004

Related U.S. Application Data
(62) Division of application No. 10/382,625, filed on Mar. 6, 2003.

(51) Int. Cl. B23P 19/00

(52) U.S. Cl. 29/456

(57) ABSTRACT

Oil country tubular goods and other types of tubular members are provided with threaded and coupled connections satisfactory for radial expansion within a wellbore. The tubular members may include couplings formed using electric resistant welding technology. The threaded and coupled connections may be used to join sections of casing with each other to form a casing string to complete a wellbore.

### RELATED APPLICATION

This application is a divisional Application based on pending application entitled “Tubular Goods With Expandable Threaded Connections” Ser. No. 10/382,625, Filing date Mar. 6, 2003 entitled “Tubular Goods With Expandable Threaded Connections” now U.S. Pat. No. ______,

### TECHNICAL FIELD

The present invention is related to tubular members and more particularly to oil country tubular goods having threaded connections which may be expanded during expansion of associated tubular goods within a wellbore.

### BACKGROUND OF THE INVENTION

Wellbores for producing oil, gas or other formation fluids from selected subsurface formations, are typically drilled in stages. For example, a wellbore may be first drilled with a drill string and a first drill bit having particular diameter. At a desired depth for a first portion of the wellbore, the drill string and drill bit are removed from the wellbore. Tubular members of smaller diameter, often referred to as casing or a casing string, may then be placed in the first portion of the wellbore. An annulus formed between the inside diameter of the wellbore and the outside diameter of the casing string is generally filled with cement. The cement provides support for the casing and isolates downhole formations or subterranean strata from each other. Many oil and gas wells are completed with relatively large diameter casing located at the well surface and smaller diameter casing extending therefrom in a telescoping or stair step pattern from the well surface to a desired downhole location.

For very deep wells and very long wells, sometimes referred to as extended reach wells (20,000 feet or greater), there may be three or four changes in casing diameter from the well surface to total depth of the wellbore. Each change in casing diameter often results in a decreasing the diameter of production tubing used to produce formation fluids from a desired downhole location. Changes in casing diameter associated with deep wells and/or long wells result in significantly increased drilling and completion costs for associated wells.

A number of oil and gas wells have been completed using solid, expandable casing. Electric resistant welded (ERW) pipe has been used to form such casing However, ERW pipe has generally not been used to provide couplings for such well completions.

### SUMMARY OF THE INVENTION

In accordance with teachings of the present invention, solid, expandable tubular goods with threaded connections are provided to complete wellbores. One aspect of the present invention includes providing threaded and coupled connections which may be used to releasably engage tubular goods with each other and to accommodate radial expansion of the tubular goods at a downhole location during completion of a wellbore. The threaded connections preferably maintain desired fluid tight seals and mechanical strength after such radial expansion.

Another aspect of the present invention includes forming a casing string with threaded and coupled flush joint type connections formed in accordance with teachings of the present invention. Each threaded connection may include a first pin member and a second pin member releasably engaged with a coupling. The pin members and the coupling may be formed using materials and techniques selected to allow radial expansion. The pin members and the coupling may be formed with substantially the same nominal outside diameter and substantially the same wall thickness. A string or series of tubular members connected with each other by threaded connections formed in accordance with teachings of the present invention will typically have a generally uniform inside diameter and a generally uniform outside diameter. For some applications such threaded connections may include modified buttress type thread forms or thread profiles with positive stab flank angles and negative load flank angles.

Technical benefits of the present invention include providing solid, expandable tubular goods with threaded connections that substantially reduce or eliminate requirements for telescoping or tapering of wellbores from an associated well surface to a desired downhole location. Such threaded connections preferably maintain both desired mechanical strength and fluid tight integrity during radial expansion of the tubular goods and their associated threaded connections. For some applications one or more thread profiles may be coated with a layer of tin, tin alloys or other materials selected to help maintain fluid tight seals between respective thread profiles of associated pin members and box members.

For one embodiment the threaded connection may include thread profiles with six buttress type threads per inch and a taper of approximately three quarters of an inch per foot. Pin ends associated with each threaded connection preferably have respective chamfers formed at an angle of approximately fifteen degrees (15°) and sized to satisfactorily engage respective shoulders formed on the interior of an associated coupling at a corresponding angle of approximately fifteen degrees (15°). Each thread form may have load flank angles of approximately minus five degrees or negative five degrees (−5°) and stab flank angles of approximately positive twenty-five degrees or plus twenty-five degrees (+25°).

Technical benefits of the present invention include providing one or more thread profiles coated or plated with materials such as tin or zinc. Heat and pressure generated during expansion of tubular goods and associated threaded connections will cause such materials to flow into any void spaces resulting from expansion of the threaded connections.

Expandable tubular goods formed in accordance with teachings of the present invention may allow wells to be completed to relatively deep geological locations or at extended distances from a production platform which may have been difficult and/or expensive to reach using traditional well drilling and casing technology. The use of solid, expandable tubular goods with threaded connections may allow wellbores to be drilled and completed with only one size of casing extending from a well surface to a relatively deep downhole location and/or extended reach location. As a result of requiring only one or two sizes of casing to complete a wellbore, surface equipment, associated drilling rigs, drill strings and bit sizes may be standardized to significantly reduce costs.

For some applications tubular goods with threaded and coupled connections formed in accordance with teachings of the present invention may be radially expanded by as much as twenty percent (20%) of their original outside diameter and satisfactorily hold as much as three thousand five hundred pounds per square inch (3,500 psi) of internal fluid pressure after such expansion. Threaded and coupled connections formed in accordance with teachings of the present invention provide required mechanical strength to complete deep and/or extended reach wellbores and provide required fluid, pressure tight seals between the interior and the exterior of associated tubular members.

### BRIEF DESCRIPTION OF THE DRAWINGS

A more complete and thorough understanding of the present invention and advantages thereof may be acquired by referring to the following description taken in conjunction with the accompanying drawings, in which like reference numbers indicate like features, and wherein:

FIG. 1A is a schematic drawing in section with portions broken away of a tubular member having a first pin end and a second pin end with respective threaded portions formed in accordance with teachings of the present invention;

FIG. 1B is an enlarged schematic drawing in section with portions broken away showing the first pin end of the tubular member of FIG. 1A;

FIG. 2A is a schematic drawing in section with portions broken away of a coupling having a first box end and a second box end with respective threaded portions formed in accordance with teachings of the present invention;

FIG. 2B is an enlarged schematic drawing in section with portions broken away showing one of two shoulders formed within the interior of the coupling of FIG. 2A;

FIG. 3 is a schematic drawing in section with portions broken away of a tubular member and a coupling releasably engaged with each other in accordance with teachings of the present invention;

FIG. 4 is a schematic drawing in section with portions broken away showing the first tubular member and coupling of FIG. 3 aligned with a second tubular member having a pin end formed in accordance with teachings of the present invention;

FIG. 5 is a schematic drawing in section with portions broken away showing the pin end of a first tubular member and an associated coupling incorporating teachings of the present invention;

FIG. 6 is a schematic drawing in section with portions broken away showing the pin end of a second tubular member and an associated coupling incorporating teachings of the present invention between; and

FIG. 7 is a schematic drawing in section with portions broken away showing the pin end of the first tubular member, the pin end of the second tubular member and the associated coupling releasably engage with each other to form a threaded and coupled flush joint type connection in accordance with teachings of the present invention;

FIG. 8 is a schematic drawing in section with portions broken away showing an enlarged view of a threaded connection with at least one threaded portion having a layer of tin disposed thereon; and

FIG. 9 is a schematic drawing in section with portions broken away showing an enlarged view of the threaded connection of FIG. 8 after radial expansion.

### DETAILED DESCRIPTION OF THE INVENTION

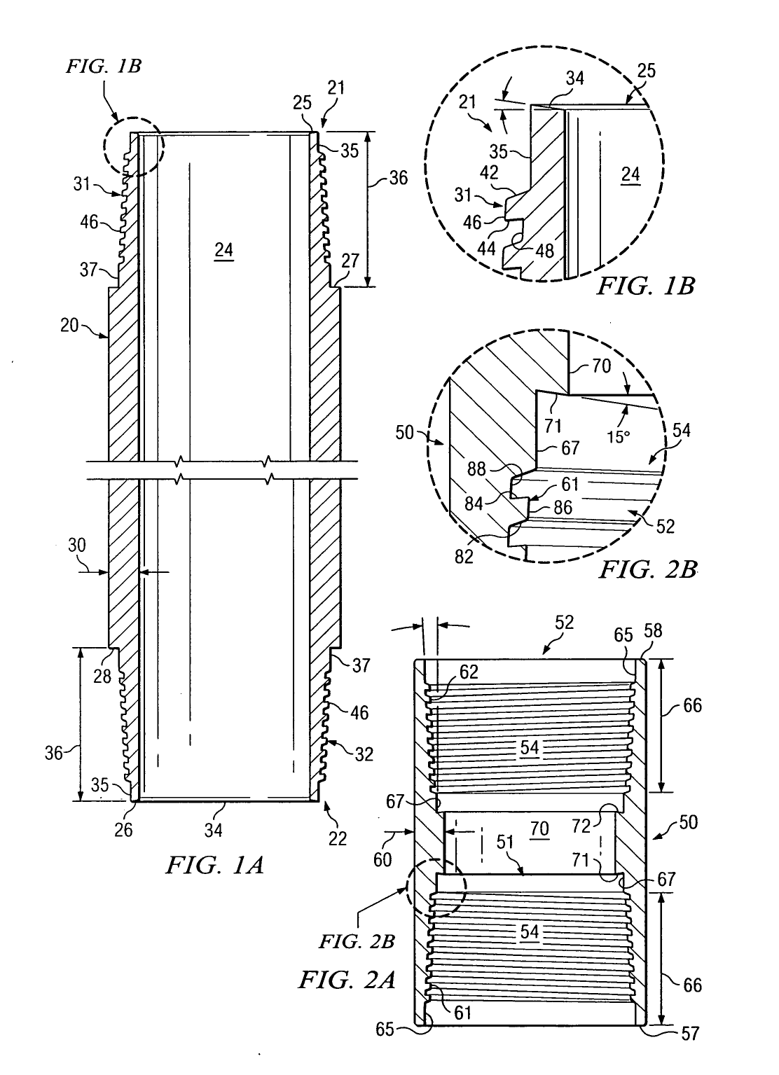

Preferred embodiments of the invention and its advantages are best understood by reference to FIGS. 1A-9 wherein like numbers refer to same and like parts.

The terms “oil country tubular goods” and “OCTG” are used in this application to include casing, tubing, pup joints, couplings and any other type of pipe or tubular member associated with drilling, producing or servicing oil wells, natural gas wells, geothermal wells or any other subsurface wellbore.

The terms “welded pipe” and “welded tubular goods” are used in this application to include any pipe, tubular member or coupling manufactured from rolled steel or steel strips which passed through forming rollers to create a longitudinal butt joint and were welded along the longitudinal butt joint. The resulting longitudinal butt weld or longitudinal seam weld may be formed using various techniques such as electric resistance welding (ERW), arc welding, laser welding, high frequency induction welding and any other techniques satisfactory for producing longitudinal seam welds. Welded pipe and welded tubular goods may be produced in individual links or may be produced in continuous links from coiled skelp and subsequently cut into individual links.

Various aspects of the present invention will be described with respect to tubular members including couplings which have been formed using electric resistant welding (ERW) technology. However, the present invention is not limited to use with tubular members produced by ERW technology. A wide variety of tubular members and oil country tubular goods (OCTG) may be releasably engaged with each other by threaded connections formed in accordance with teachings of the present invention.

Prior to the present invention, welded pipe was not generally used to provide couplings for use in completing oil and gas wells. ERW technology typically allows better quality control of wall thickness associated with welded pipe and minimizes material defects. A coupling formed in accordance with teachings of the present invention from ERW pipe will generally have better performance characteristics, such as mechanical strength and fluid tight integrity after radial expansion as compared with couplings formed from seamless pipe.

Various aspects of the present invention will be discussed with respect to tubular members 20 and couplings 50 as shown in FIGS. 1A-9. To describe some features of the present invention, tubular members 20 may sometimes be designated as 20a and 20b. For some applications, tubular members 20 may be sections of a casing string used to complete a wellbore (not expressly shown). For such applications, each tubular member 20 and coupling 50 may have some overall dimensions and configurations compatible with a conventional oil field casing string. For other applications, various types of downhole well completion tools (not expressly shown) may have threaded portions corresponding with threaded portions of tubular members 20 and/or couplings 50. For example, a liner hanger (not expressly shown) may be formed with a pin end and/or a box end having dimensions corresponding respectively with the pin ends of tubular member 20 or the box ends of coupling 50.

FIG. 1 shows tubular member 20 which may be formed using electric resistance welding (ERW) technology. For this embodiment, tubular member 20 may be generally described as an elongated, hollow section of casing. Tubular member 20 includes first end 21 and second end 22 with longitudinal bore 24 extending therethrough. Threaded portions 31 and 32 incorporating teachings of the present invention having matching external thread profiles are preferably formed on respective first end 21 and second end 22 of tubular member 20. First end 21 and second end 22 may sometimes be referred to as “pin ends”. First threaded portion 31 and second threaded portion 32 may have thread forms or thread profiles similar to American Petroleum Institute (API) buttress threads for oil country tubular goods. API Specification Standard 5B contains information for various types of threads associated with OCTG.

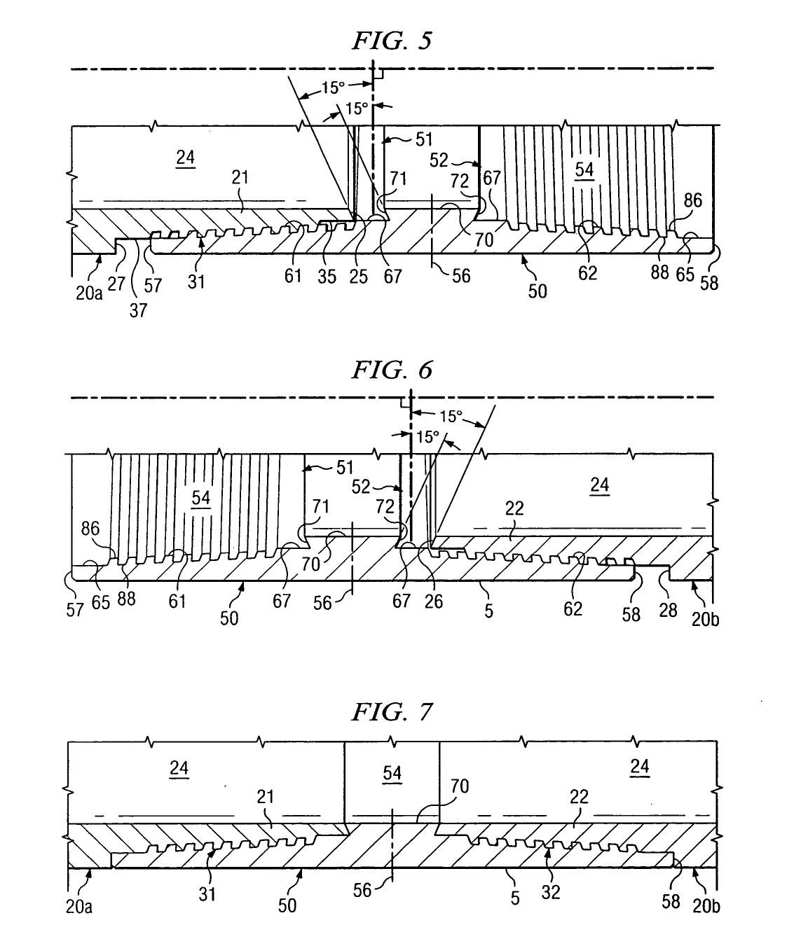

First end or pin end 21 of tubular member 20 may sometimes be described as a “mill end” or “factory end.” Second end or pin end 22 may be described as a “field end”. The relationship between mill end 21, field end 22 and coupling 50 are shown in more detail in FIGS. 5, 6 and 7. Various features associated with threaded portions 31 and 32 will be described with respect to center plane 56 and other portions of associated coupling 50.

FIG. 2 shows coupling 50 which may be formed using electric resistance welding (ERW) technology. For some applications, tubular member 20 and coupling 50 may be formed from the same type of material. Coupling 50 may be generally described as a relatively short section of welded pipe defined in part by first end or box end 51 and second end or box end 52 with longitudinal bore 54 extending therebetween. Threaded portions 61 and 62 incorporating teachings of the present invention are preferably formed within longitudinal bore 54 extending respectively from first extreme end 57 and second extreme end 58. Threaded portions 61 and 62 may have matching internal thread profiles.

Threaded portions 61 and 62 terminate proximate respective shoulders 71 and 72 of flange 70. Shoulders 71 and 72 may be formed with a negative angle compatible with respective chamfers 34 having positive angles formed on extreme end 25 of pin end 21 and extreme end 26 of pin end 22. For some applications, threaded portions 61 and 62, flange 70 and shoulders 71 and 72 may be formed by a single pass of a thread cutting machine through a longitudinal bore of a coupling blank (not expressly shown). The coupling blank may be cut from a weld pipe (not expressly shown) with overall dimensions length, outside diameter, inside diameter and wall thickness desired for coupling 50. Center plane 56 defines approximately the middle of coupling 50 between shoulders 71 and 72. For some applications threaded portions 31, 32, 61 and 62 may have generally tapered thread profiles.

For some embodiments of the present invention as shown in FIGS. 1A-9, threaded portions 31 and 32 and threaded portions 61 and 62 may be generally described as having modified buttress thread forms. Threaded portions 31 and 32 and threaded portions 61 and 62 formed in accordance with teachings of the present invention preferably include several significant differences as compared with more conventional buttress thread forms. For example, thread forms or thread profiles associated with threaded portions 31, 32, 61 and 62 preferably having negative load flank angles and positive stab flank angles. The tapered thread profiles associated with threaded portions 31,32, 61 and 62 and the positive flank angles cooperate with each other to facilitate make of first pin end 21 with first box end 51 and second pin end 22 with second box end 52.

As shown in FIG. 1B thread forms associated with threaded portion 31 include first flank or stab flank 42 and second flank or load flank 44 extending between respective thread crests 46 and thread roots 48. In a similar manner as shown in FIG. 2B, thread forms associated with threaded portion 61 include first flank or stab flank 82 and second flank or load flank 84 extending between respective thread crests 86 and thread roots 88. For some applications, first flanks or stab flanks 42 and 82 may be formed at an angle of approximately positive twenty-five degrees (+25°) relative to the inside diameter of longitudinal bore 54. Second flanks or load flanks 44 and 84 may be formed at an angle of approximately negative five degrees (−5°) relative to the same axis.

First flank angles or stab flank angles formed in accordance with teachings of the present invention may vary for some applications between approximately positive ten degrees (+10°) and positive forty-five degrees (+45°). For some applications, threaded connections formed in accordance with teachings of the present invention may have second flank angles or load flank angles between approximately negative three degrees (−3°) and negative fifteen degrees (−15°).

For some applications thread roots 88 of threaded portions 61 and 62 may be larger (for example 0.001 inches) than thread crests 46 of threaded portions 31 and 32 to accommodate redistribution and flow of coating 100 during both power tight make up of associated threaded connections and downhole radial expansion of tubular members 20 and coupling 50. The height of thread crests 46 and 86 may be reduced to increase the mechanical strength of the associated threaded connection. For example thread crests 46 and 86 may have a height of approximately 0.052 inches as compared with more typical buttress thread heights of 0.062 inches.

As shown in FIGS. 1A and 1B, respective chamfered surfaces 34 are preferably formed at extreme ends 25 and 26 of first end 21 and second end 22. For some applications chamfered surfaces 34 may extend at an angle of approximately positive fifteen degrees (+15°) relative to the inside diameter of longitudinal bore 24. First shoulder 71 and second shoulder 72 of coupling 50 are preferably formed on flange 70 at an angle of approximately negative fifteen degrees (−15°) relative to the inside diameter of longitudinal bore 54. For other applications a positive angle between approximately seventy-five degrees (+75°) and ninety degrees (+90°) may be formed on each chamfered surface 34. A generally corresponding negative angle between approximately fifteen degrees (−15°)and zero degrees (0°) may be formed with respective shoulders 71 and 72.

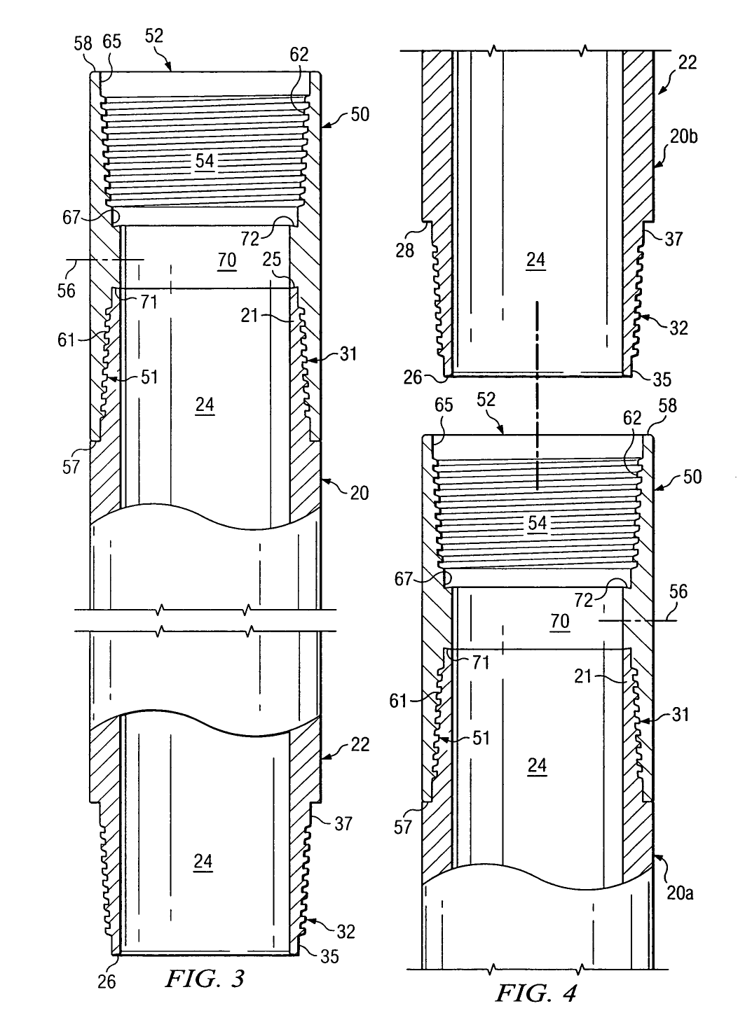

Tubular member 20 and coupling 50 formed in accordance with the teachings of the present invention are shown releasably engaged with each other in FIG. 3. Tubular member 20 and coupling 50 may be formed from ERW pipe having substantially the same outside diameter, inside diameter and wall thickness. As a result, when first pin end 21 of tubular member 20 is releasably engaged with first box end 51 of coupling 50, the resulting threaded connection may be described as “flush” with respect to outside diameters of tubular member 20 and coupling 50 and inside diameters of longitudinal bores 24 and 54. See FIGS. 3 and 4.

Various types of powered tools and equipment (not expressly shown) may be satisfactorily used to releasably engage coupling 50 with threaded portion 31 of first pin end 21. As previously noted, coupling 50 preferably has matching internal threaded portions 61 and 62. Therefore, either first box end 51 or second box end 52 of coupling 50 may be releasably engaged with first pin end 21. For purposes of describing various features of the present invention, the process of making up or releasably engaging coupling 50 with first pin end 21 will be described with respect to first box end 51. In a similar manner, releasable engagement of second pin end 22 with coupling 50 will be described with respect to second box end 52. However, first pin end 21 may be satisfactorily engaged with second box end 52 of coupling 50 and second pin end 22 may be satisfactorily engaged with first box end 51 of coupling 50.

For some applications, tubular member 20 may be initially formed with blank ends (not expressly shown). Respective threaded portions 31 and 32 may then be formed on first pin end 21 and second pin end 22 using conventional pipe threading machines and equipment (not expressly shown). After forming threaded portions 31 and 32 on tubular member 20, coupling 50 may be releasably engaged with first pin end 21. See FIG. 3. Tubular member 20 may then be shipped from a manufacturing facility (not expressly shown) along with coupling 50. Therefore, first pin end 21 with coupling 50 attached thereto may sometimes be referred to as a “factory end” or “mill end.”

FIG. 4 shows a typical orientation of first tubular member 20a and second tubular member 20b prior to making up the tubular members for insertion into a wellbore (not expressly shown). The present invention allows multiple tubular members 20 to be releasably engaged with each other to form a casing string to complete a wellbore. Generally, first tubular member 20a will be positioned on a drilling platform or well servicing platform (not expressly shown) over a wellbore with second end or box end 52 of coupling 50 looking up to receive second pin end or field end 22 of second tubular member 20b. Various types of pipe tongs and other equipment associated with making and breaking threaded connections between oil country tubular goods may be satisfactorily used to releasably engage second pin end 22 of second tubular member 20b with second box end 52 of coupling 50.

Tubular members 20 are preferably formed with nominal wall thickness 30 which is approximately equal to nominal wall thickness 60 of couplings 50. Also, length 36 of threaded portions 31 and 32 may be approximately equal to length 66 of threaded portions 61 and 62. As a result of having substantially the same nominal wall thickness and approximately the same length of threaded portions when tubular members 20a and 20b are releasably engaged with coupling 50 as shown in FIG. 7, a flush type joint connection is provided with a substantially uniform inside diameter and a substantially uniform outside diameter.

Length 36 for threaded portion 31 may be measured from extreme end 25 of first pin end 21 to shoulder 27 formed on the exterior of tubular member 20 extending generally normal to longitudinal bore 24 proximate the last vanishing thread of threaded portion 31. Length 36 of threaded portion 32 may be measured from extreme end 26 to shoulder 28 formed on the exterior of tubular member 20 extending generally normal to longitudinal bore 24 proximate the last vanishing thread of threaded portion 32. See FIG. 1A.

Length 66 of threaded portion 61 may be measured from extreme end 57 of first box end 51 to the last vanishing thread of threaded portion 61 proximate first shoulder 71 formed on flange 70. Length 66 of threaded portion 62 may be measured from extreme end 58 of second box and 52 to the last vanishing thread of threaded portion 62 proximate second shoulder 72 formed on flange 70. Length 36 of threaded portions 31 and 32 and length 66 of threaded portions 61 and 62 are preferably selected so that extreme end 25 of first pin end 21 will abut shoulder 71 of flange 70 and extreme end 26 of second pin end 22 will abut shoulder 72 when respective threaded portions 31 and 32 are engaged with coupling 50. Shoulder 27 on the exterior of tubular member 20a will preferably abut extreme end 57 of box end 51. Shoulder 28 on the exterior of tubular member 20b will preferably abut extreme end 58 of box end 52. See FIGS. 5, 6 and 7.

Threaded connections as shown in API Specification Standard 5B may be made up to a “basic hand-tight position” and to a “basic power-tight position” as indicated by markings on the exterior of associated oil country tubular goods. The hand tight position for factory end or first pin end 21 relative to coupling 50 is shown in FIG. 5. The hand tight position for field end or second pin end 22 relative to coupling 50 is shown in FIG. 6. Power tight positions for factory end or first pin end 21 and field end or second pin end 22 relative to coupling 50 are shown in FIG. 7.

For some applications threaded portions 31, 32, 61 and 62 may have matching thread profiles with at least six (6) threads per inch. Various dimensions associated with threaded portions 31, 32, 61 and 62 may be selected to provide a hand tight position defined in part by a stand off of approximately two (2) threads between extreme end 25 of tubular member 20a and first shoulder 71 of coupling 50. See FIG. 5. A similar hand tight position with a two (2) thread stand off may be provided between extreme end 26 of tubular member 20b and shoulder 72 of coupling 50. See FIG. 6. One example of dimensions associated with a threaded connection having a hand tight position with a two thread stand off are shown in Table 1. A typical stand off for threaded connections associated with oil country tubular goods that have a hand tight position will often be one thread or less. The two thread stand off in the hand tight position assists in maintaining mechanical integrity and fluid tight or pressure tight integrity of the associated threaded connection during radial expansion.

For some applications, relatively smooth nonthreaded portions designated 35 may be formed as part of threaded portions 31 and 32 extending from respective extreme ends 25 and 26. Corresponding smooth nonthreaded portions designated 65 may be formed as part of threaded portions 61 and 62 extending from respective extreme ends 57 and 58 of coupling 50. Relatively smooth nonthreaded smooth portions 37 may also be provided as part threaded portion 31 extending from shoulder 27 and threaded portion 32 extending from shoulder 28. Generally matching nonthreaded portions 67 may be provided as part of threaded portions 61 and 62 extending from respective shoulders 71 and 72.

Engagement between these nonthreaded portions 35, 37, 65 and 67 of pin end 21 and box end 51 and pin end 22 and box end 52 cooperate with each other to improve performance of associated threaded connections during radial expansion of tubular members 20a, 20b and coupling 50 at a down hole location within a wellbore. When an expansion mandrel or similar tool moves through longitudinal bores 24, direct contact between nonthreaded portions 35 and 67 and 37 and 65 will result in radial expansion without disengagement of the associated threaded portions 31 and 61 and threaded portions 32 and 62. For some applications, nonthreaded portions 35, 36, 65 and 67 may have a length of approximately one (1) inch. Nonthreaded portions 35, 36, 65 and 67 cooperate with each other to coordinate radial expansion of first pin end 21 with first box end 51 and second pin end 22 with second box end 52 during deformation of the threaded connection.

A threaded and coupled flush joint type connection formed in accordance with teachings of the present invention may have a power-tight position defined in part by extreme end 26 of field end 22 of tubular member 20b directly contacting shoulder 72 and extreme end 25 of the mill end 21 of tubular member 20b directly contacting shoulder 71 of associated coupling 50. The power-tight position for releasably engaging tubular members 20a, 20b and coupling 50 with each other is shown in FIG. 7.

Various features of tubular goods and threaded connections formed in accordance with teachings of the present invention allow radial expansion of the tubular goods and threaded connections while maintaining desired mechanical strength and fluid tight integrity. These features include negative load flank angles 44 and 84 which retain close, intimate contact between associated threaded portions 31 and 61 and threaded portions 32 and 62 during radial expansion of tubular members 20, couplings 50 and associated threaded and coupled connection. The negative angle of the load flanks may be selected to provide desired tensile strength to prevent disengagement of associated threaded portions 31 and 61 and threaded portions 32 and 62 during radial expansion.

Another feature of the present invention which helps maintain desired fluid tight integrity during radial expansion includes chamfers 34 formed on extreme ends 25 and 26 of pin ends 21 and 22 and shoulders 71 and 72 formed within coupling 50. As previously noted, shoulders 71 and 72 are preferably formed with a negative angle selected to match a corresponding positive angle associated with chamfers 34. The associated angles and the tensile strength of material used to form tubular members 20 and couplings 50 cooperate with each other to retain close, intimate contact between extreme ends 25 and 26 of pin members 21 and 22 and respective shoulders 71 and 72.

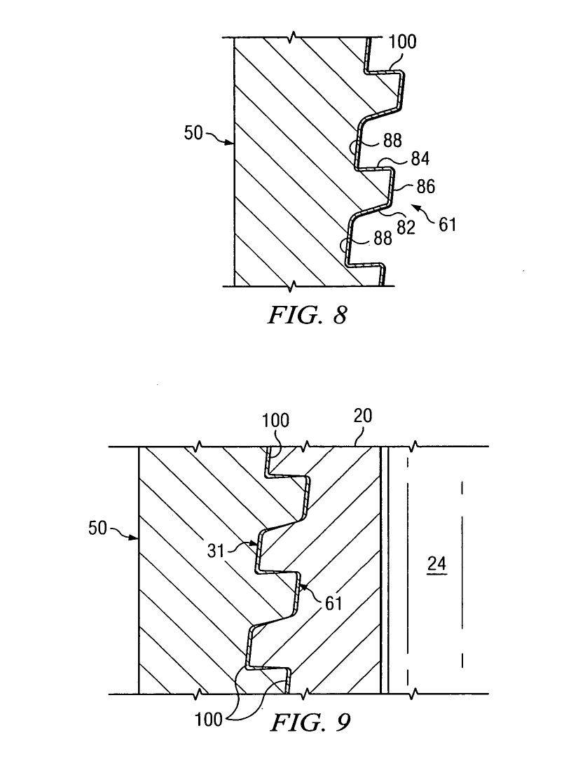

For some applications, a layer of tin based material or other suitable material may be coated or plated on threaded portions 31, 32, 61 and 62. For the embodiment of the present invention as shown in FIGS. 8 and 9, coating 100 may be disposed on internal threaded portions 61 and 62 of coupling 50. For purposes of illustrating various features of the present invention the thickness of coating 100 is shown larger than a typical coating on a threaded connection formed in accordance with teachings of the present invention. Modified buttress thread forms associated with threaded portions 31, 32, 61 and 62 and coating 100 cooperate with each other to provide improved fluid tight integrity with respect to internal fluid pressure following radial expansion of tubular members 20, couplings 50 and associated threaded and coupled connections. Coating 100 may be applied by various processes such as plating after threaded portions 61 and 62 have been machined within coupling 50.

Various types of downhole tools such as an “expansion mandrel” (not expressly shown) may be used to radially expand tubular members 20 and couplings 50 when the associated casing string is disposed at a desired downhole location. During a typical expansion process, pressure or force may be exerted by the expansion mandrel pressing against the inside diameter of respective pin members 21 and 22. Resulting radial forces may be transferred to respective box ends 51 and 52 which result in radial expansion of each coupling 50. Such pressure and associated friction will typically cause portions of coating 100 disposed between threaded portions 31 and 61 and threaded portions 32 and 62 to flow and fill any gaps or void spaces formed within respective threaded portions which may have occurred during the downhole radial expansion process. See FIG. 9.

For some applications, specifications associated with threaded portions 31, 32, 61 and 62 may be selected to provide approximately 0.0005 inches of clearance between respective flank angles 42 and 82 and flank angles 44 and 84 and approximately zero clearance between respective roots 48 and 88 and crests 46 and 86. During makeup of an associated threaded and coupled connection, portions of coating 100 will typically be displaced from respective flanks 82 and 84 and deposited in thread roots 48 and 88. The presence of excess coating 100 in roots 48 and 88 may result in some radial deflection of pin ends 21 and 22 into longitudinal bore 24 during make up of tubular members 20a and 20b with coupling 50.

Chamfers 34 formed on pin ends 21 and 22 will engage or lock with respective shoulders 71 and 72 to minimize the effects of such radial deflection. In a similar manner, negative load flank angles 44 and 84 will engage or lock with each other to also minimize the effects of such radial deflection. For some applications pin ends 21 and 22 may deflect radially inward approximately 0.002 inches during power tight make of the associated threaded 5 connection. Radial expansion of tubular members 20 and couplings 50 at a downhole location substantially reduces or removes any inward deflection of pin ends 21 and 22.

TABLE 1
EXAMPLES OF SOME TYPICAL DIMENSIONS FOR THREAD PROFILES
ON PIN ENDS AND COUPLING

| | | | | | | End of Pipe | Length | |
|---|---|---|---|---|---|---|---|---|
| | | | | | | to Center | Face of | |
| Size | | Length | | | Pitch | of Coupling | Coupling | Taper |
| Nominal | Threads | Perfect | | | Diameter | Hand Tight | to Plane | Per |
| OD | Per Inch | Threads | E7 | L4 | at E7 | Standoff | of E7 | Foot |
| 6.000 | 6 | 2.000 | 1.300 | 2.600 | 5.7155 | 0.3334 | 0.9666 | 0.750 |

| | | | BHS | B1 | C | D | E |
|---|---|---|---|---|---|---|---|
| Size | A | A1 | Pin Recess | Pin Recess | Angle of | Angle of | Length |
| Nominal | Pin Nose | Pin Nose | Diameter at | Length at | Pin Bevel at | Coupling | Center of |
| OD | Diameter | Length | Shoulder | Shoulder | End of Pipe | Shoulder | Coupling |
| 6.000 | 5.570 | 0.300 | 5.830 | 0.300 | 15° | 75° | 1.000 |

| | F | F1 | G | G1 | | |
|---|---|---|---|---|---|---|
| | Diameter of | Length of | Diameter of | Length of | | |
| | Coupling | Coupling | Coupling | Coupling | J | |
| Size | Counterbore | Counterbore | Recess at | Recess at | Length | K |
| Nominal | Recess at Face | Recess at Face | Center of | Center of | of | Wall |
| OD | of Coupling | of Coupling | Coupling | Coupling | Coupling | Thickness |
| 6.000 | 5.840 | 0.300 | 5.580 | 0.300 | 6.200 | 0.305 |

NOTE:
Diameter and length dimensions in Table 1 are in inches.

Although the present invention and its advantages 15 have been described in detail, it should be understood that various changes, substitutions and alternations can be made herein without departing from the spirit and scope of the invention as defined by the following claims.

What is claimed is:

1. A method of forming an expandable section of casing for use in completing a wellbore, comprising:
forming a first, elongated tubular member using electric resistance welding techniques;
forming a first pin end and a second pin end on the first tubular member with a longitudinal bore extending through the first tubular member from the first pin end to the second pin end;
forming a first tapered, exterior threaded portion on the first pin end of the first tubular member;
forming a second, tapered exterior threaded portion on the second pin end of the first tubular member;
forming a coupling from electric resistance welded pipe with a longitudinal bore extending through the coupling from a first box end to a second box end;
forming a first tapered, internal threaded portion within the longitudinal bore of the coupling extending from the first box end to a first shoulder formed within the coupling;
forming a second tapered, internal threaded portion within the longitudinal bore of the coupling extending from the second box end to a second shoulder formed within the coupling; and
releasably engaging the first pin end of the first, elongated tubular member with one of the internal, tapered threaded portions of the coupling.

2. The method of claim 1 further comprising coating at least one of the threaded portions with a layer of material which will become malleable and flow in response to heat and pressure resulting from radial expansion of the first tubular member and the coupling to fill any gaps or void spaces formed between adjacent threaded portions.

3. The method of claim 2 further comprising forming the coating on the at least one threaded portion from a tin based material.

4. The method of claim 2 further comprising coating the first internal threaded portion and the second internal threaded portion with a tin based material.

5. The method of claim 1 further comprising:
initially engaging the first box end of the coupling with the first pin end of the first tubular member in a hand tight position defined in part by a stand off of approximately two threads between an extreme end of the first pin end and the first shoulder formed within the coupling; and
securely engaging the first box end of the coupling with the first pin end of the first tubular member in a power tight position defined in part by the extreme end of the first pin end directly abutting the first shoulder formed within the coupling.

6. The method of claim 1 further comprising forming the first tapered, external thread profile and the second tapered, external thread profile with matching modified buttress thread forms.

7. The method of claim 1 further comprising:
forming a chamfer on the first pin end having a positive angle of approximately fifteen degrees (+15°); and
forming a chamfer on the second pin end having a positive angle of approximately fifteen degrees (+15°).

8. The method of claim 1 further comprising:
forming a second, elongated tubular member having a first pin end, second pin end, longitudinal bore, first tapered, exterior threaded portion and second tapered, exterior threaded portion corresponding generally with the first elongated tubular member; and
releasably engaging the second pin end of the second tubular member with the other threaded portion of the coupling.

9. The method of claim 8 further comprising forming each tubular member and the coupling from electric resistance welded pipes with approximately the same outside diameter and approximately the same inside diameter.

10. A method to form solid, expandable tubular members comprising:
forming a first, elongated tubular member using electric resistance welding techniques with a longitudinal bore extending through the first tubular member;
forming a first pin end on the first tubular member with a first tapered, exterior threaded portion disposed on the first pin end;
forming a second pin end on the first tubular member with a second, tapered exterior threaded portion disposed on the second pin end;
forming a coupling from electric resistance welded pipe with a longitudinal bore extending through the coupling from a first box end to a second box end;
forming a first tapered, internal threaded portion within the longitudinal bore of the coupling extending from the first box end to a first shoulder formed within the coupling;
forming a second tapered, internal threaded portion within the longitudinal bore of the coupling extending from the second box end to a second shoulder formed within the coupling;
coating at least one of the threaded portions with a layer of material which will become malleable and flow in response to heat and pressure resulting from radial expansion of the first tubular member and the coupling to fill any gaps or void spaces formed between adjacent threaded portions; and
releasably engaging the first pin end of the first, elongated tubular member with one of the internal, tapered threaded portions of the coupling.

11. The method of claim 10 further comprising forming the coating on the at least one threaded portion from a tin based material.

12. The method of claim 10 further comprising coating the first internal threaded portion and the second internal threaded portion of the coupling with a tin based material.

13. The method of claim 10 further comprising:
initially engaging the first box end of the coupling with the first pin end of the first tubular member in a hand tight position defined in part by a stand off of approximately two threads between an extreme end of the first pin end and the first shoulder formed within the coupling; and
securely engaging the first box end of the coupling with the first pin end of the first tubular member in a power tight position defined in part by the extreme end of the first pin end directly abutting the first shoulder formed within the coupling.

14. The method of claim 10 further comprising:
forming a second, elongated tubular member using electric resistance welding techniques with a first pin end, second pin end, longitudinal bore, first tapered, exterior threaded portion and second tapered, exterior threaded portion corresponding generally with the first elongated tubular member; and
releasably engaging the second pin end of the second tubular member with the other threaded portion of the coupling.

15. A method of forming an expandable section of casing for use in completing a wellbore, comprising:
forming a first, elongated tubular member using electric resistance welding techniques;
forming a first pin end and a second pin end on the first tubular member with a longitudinal bore extending through the first tubular member from the first pin end to the second pin end;
forming a first tapered, exterior threaded portion on the first pin end of the first tubular member;
forming a second, tapered exterior threaded portion on the second pin end of the first tubular member;
forming a coupling from electric resistance welded pipe with a longitudinal bore extending through the coupling from a first box end to a second box end;
forming a first tapered, internal threaded portion within the longitudinal bore of the coupling extending from the first box end to a first shoulder formed within the coupling;
forming a second tapered, internal threaded portion within the longitudinal bore of the coupling extending from the second box end to a second shoulder formed within the coupling;
forming the first tapered, external thread profile and the second tapered, external thread profile with matching modified buttress thread forms;
forming a chamfer on the first pin end having a positive angle of approximately fifteen degrees (+15°);
forming a chamfer on the second pin end having a positive angle of approximately fifteen degrees (+15°); and
releasably engaging the first pin end of the first, elongated tubular member with one of the internal, tapered threaded portions of the coupling.

16. The method of claim 15 further comprising:
forming a second, elongated tubular member using electric resistance welding techniques with a first pin end, second pin end, longitudinal bore, first tapered, exterior threaded portion and second tapered, exterior threaded portion corresponding generally with the first elongated tubular member; and
releasably engaging the second pin end of the second tubular member with the other threaded portion of the coupling.

17. The method of claim 15 further comprising forming each tubular member and the coupling from electric resistance welded pipes with approximately the same outside diameter and approximately the same inside diameter.

18. A method for releasably coupling tubular members with each other, comprising:
forming a coupling having a first box end and a second box end with a first tapered, internal threaded portion formed within the first box end and a second tapered, internal threaded portion formed within this second box end of the coupling;
forming a flange on an interior of the coupling intermediate the first box end and the second box end with the flange having a first shoulder and a second shoulder projecting radially into the longitudinal bore;
terminating the first tapered, internal threaded portion proximate the first shoulder;
terminating the second tapered, internal threaded portion proximate the second shoulder;
forming a first tubular member having a first pin end and a second pin end with a respective tapered, external threaded portion on the first pin end and the second pin end with a respective stab flank angle with a value between approximately positive ten degrees (+10°) and positive forty-five (+45°) degrees and a respective load flank angle with a value between approximately negative three degrees (−3°) and negative fifteen degrees (−15°);
forming respective chamfers on the first pin end and the second pin end of the first tubular member with each chamfer having a positive angle between approximately seventy-five degrees (+75°) and ninety degrees (+90°);
forming the first shoulder and the second shoulder of the coupling with a negative angle between approximately fifteen degrees (−15°) and zero degrees (0°) whereby the angle of the chamfers and the angle of the shoulders selected to allow the chamfer of each pin end to securely engage one of the first shoulder and the second shoulder; and
releasably engaging the first box end of the coupling with either the first pin end or the second pin end of the tubular member.

19. The method of claim 18 further comprising forming each stab flank angle with a value of approximately positive twenty five degrees (+25°)and forming each load flank angle with a value of approximately negative five degrees (−5°).

20. The method of claim 18 further comprising forming the tubular members and the coupling from electric resistance welded pipe.

21. The method of claim 18 further comprising forming the angle of each chamfer with a value of approximately positive fifteen degrees (+15°) and forming the angle of each shoulder with a value of approximately negative fifteen degrees (−15°).

22. A method for forming a solid, expandable section of casing for using in completing a wellbore comprising:
forming a first tubular member and a coupling using electric resistance welded pipe;
forming the first tubular member with a first pin end and a second pin end with a longitudinal bore extending through the first tubular member between the first pin end and the second pin end;
forming a first external threaded portion on the first pin end and a second external threaded portion on the second pin end;
forming the coupling with a first box end and a second box end and a longitudinal bore extending through the coupling from the first box end to the second box end;
forming a first internal threaded portion within the first box end of the coupling;
forming a second internal threaded portion within the second box end of the coupling;
forming a flange disposed within the coupling between the first internal threaded portion and the second internal threaded portion;
releasably engaging the first external threaded portion of the first tubular member with one of the internal threaded portions of the coupling;
forming the first and second external threaded portions and the first and second internal threaded portions having at least six threads per inch;
initially engaging the coupling with the first tubular member in a hand tight position defined in part by a stand off of approximately two threads between an extreme end of the first pin member and a first shoulder of the flange; and
further engaging the coupling with the first tubular member in a power tight position defined in part by the extreme end of the first pin end of the first tubular member directly abutting the first shoulder of the flange.

23. The method of claim 22, further comprising:
forming a second tubular member from electric resistant welded pipe with a first pin end and a second pin end with a longitudinal bore extending through the second tubular member from the first pin end to the second pin end;
forming a first external threaded portion on the first pin end and a second external threaded portion formed on the second pin end;
initially engaging the second tubular member with this coupling in a hand tight position defined in part by a stand off of approximately two threads between an extreme end of the second pin member and a second shoulder of the flange; and
further engaging the second tubular member with the coupling in a power tight position defined in part by the extreme end of the second pin end of the second tubular member directly abutting the second shoulder of the flange.
